(19) United States
(12) Patent Application Publication
(10) Pub. No.: US 2022/0202526 A1
(43) Pub. Date: Jun. 30, 2022

(54) DENTAL ABRASIVE DISK

(71) Applicant: DANIEL SUNG-YUL KIM, VANCOUVER, WA (US)

(72) Inventor: DANIEL SUNG-YUL KIM, VANCOUVER, WA (US)

(21) Appl. No.: 17/696,657

(22) Filed: Mar. 16, 2022

Related U.S. Application Data
(63) Continuation-in-part of application No. 16/258,328, filed on Jan. 25, 2019, now abandoned.
Application No. 16/258,328 is a continuation of application No. 15/379,145, filed on Dec. 14, 2016, now abandoned.
(60) Provisional application No. 62/267,145, filed on Dec. 14, 2015.

(51) Int. Cl. A61C 3/06; A61C 15/00

(52) U.S. Cl. CPC A61C 3/06; A61C 15/00

(57) ABSTRACT

A dental abrasive disk, defined by a disk radius, an outer perimeter edge, opposite first and second surfaces and a base thickness, includes a center coupling and at least one of the first or second surfaces having an inner abrasive zone and an outer nonabrasive zone, the ratio of nonabrasive zone depth to disk radius in the range 20% to 40%. The disk may include dimpled surfaces. The disk may include a distributed pattern of perforations. The disk may include a beveled or radiused edge. The disk may include a serrated perimeter edge.

### CROSS-REFERENCE TO RELATED APPLICATIONS

This Application is a continuation-in-part of and claims priority to U.S. patent application Ser. No. 16/258,328 filed on Jan. 25, 2019. Application Ser. No. 16/258,328 is a continuation of and claims priority to U.S. patent application Ser. No. 15/379,145 filed Dec. 14, 2016. U.S. application Ser. No. 15/379,145 is a nonprovisional of, and claims priority to, U.S. Provisional Patent Application Ser. No. 62/267,145 filed on Dec. 14, 2015. This Application claims priority to each of the preceding applications and each of the preceding applications is incorporated herein in their entirety.

### FIELD OF THE INVENTION

The present invention relates to improvements to dental interproximal abrasive disks.

### BACKGROUND

Interproximal reduction (IPR) involves removing enamel or crown material along the interproximal contact area between teeth in order to reduce teeth crowding and/or to remove excess interproximal material from crowns or other dental restorations.

Dentists and dental surgeons performing IPR have long struggled with several major problems, including damage to interproximal gingival tissue and misalignments causing excessive enamel removal and/or misshapen surfaces on the teeth. Currently, only non-edge-safe dental abrasive disks are available, which are coated with abrasive material, such as diamond dust or similar coatings on at least one side extending to the outer perimeter edge of the disk, and actually along the radial edge of the disk. A problem arises that when orthodontic dentists do IPR between teeth, the tight space within a patient's mouth frequently—inevitably—causes the dentist to tilt the disk at the edge portion out of alignment with the patient's teeth, so it digs into the enamel near the gingiva leaving ledges just under the papilla. Referring to FIGS. 6-7, prior art apparatus are shown, demonstrating problems with prior art devices addressed by the inventor's new design. The dentist cannot easily detect this misalignment as it happens, and so is unable to adequately prevent it. Additionally, due to the tight space and limited visibility, the abrasive surfaces may contact the gingival tissue causing significant damage, which the dentist may only become aware of due to the blood flow into the IPR, and the tissue damage of a nature which takes a long time to heal and is very susceptible to infection.

Additionally, excessive heat generation is known to damage the tooth pulp, so it is desirable to reduce the area of active abrasion at any given time—i.e. the greater the area of active abrasion the greater the frictional heat load generated, potentially causing excessive heat buildup and damage to the pulp.

With this new safe-edge disk that would not have diamond particles coated on the outer 1-2 mm, it would not dig into the enamel at the gingival margin. The diamond particles are coated on each single side and double-sided, on the interior disk surfaces, to provide the enamel removing function.

### SUMMARY AND ADVANTAGES

A dental abrasive disk includes a round disk with an outer region having no abrasive surface, or a reduced abrasive surface, and an inner region having first and/or second abrasive surfaces. An improved dental abrasive disk may include a sawtooth outer perimeter edge. An improved dental abrasive disk may include may include wherein the first and or second surfaces are dimpled, warned or honeycombed, with the outer region including no abrasive coating and thereby having a lower abrasion than an abrasive coated interior region, but providing greater rigidity for a given thickness, reducing potential for binding, and creating a friction-reducing boundary later by the action of the dimpled surface. The ratio of the depth of the nonabrasive region to the disk radius may be in the range 20%-40%. The perimeter edge may include beveling or radiusing of the outer nonabrasive zone, and may include a serrated/sawtooth profile to provide simultaneous cutting/separation and polishing ability and/or with reduced frictional heating.

The improved dental abrasive disk has many advantages, including: (1) providing the ability to ensure proper alignment of the disk prior to the high-abrasion portion contacting a tooth and/or crown surfaces; (2) reducing risk of excessive enamel reduction proximate the gingival surface; (3) providing better control inserting the disk into the interproximal region with less kick-back; (4) reducing risk to interproximal gingival tissue; (5) reducing risk of excessive frictional heat generation which may damage tooth pulp; and, (6) more efficient separation and polishing by combining them in one step or requiring fewer steps.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIG. 1 shows a front view of a first embodiment.

FIG. 2 shows front view of a second embodiment.

FIG. 3 shows a front view of a third embodiment.

FIG. 4 shows an edge view of a first embodiment in use.

FIG. 5 shows an edge view of a first embodiment in use.

FIG. 5a shows perspective view of a first embodiment in use.

FIG. 6 shows an edge view of a prior art device in use.

FIG. 6a shows perspective view of a prior art device in use.

FIG. 7 shows multiple views of prior art devices in use, demonstrating misalignment problems.

FIG. 8 shows a partial cross-section view of a fourth embodiment.

FIG. 9 shows a partial cross-section view of a fifth embodiment.

FIG. 10 shows a partial cross-section view of a sixth embodiment.

FIG. 11 shows a partial cross-section view of a seventh embodiment.

FIG. 12 shows a partial cross-section view of a fourth embodiment in use.

### REFERENCE NUMBERS USED IN THE DRAWINGS

Turning now descriptively to the drawings, in which similar reference characters denote similar elements throughout the several views, the figures illustrate the of the present invention. With regard to the reference numerals used, the following numbering is used throughout the various drawing figures:

| Reference | |
|---|---|
| Number | Description |
| 10 | First Embodiment |
| 12 | Disk Perimeter Edge |
| 14 | Disk Outer Diameter |
| 16 | First Aperture |
| 18 | Disk First Surface |
| 20 | Disk Second Surface |
| 22 | First Surface Abrasive Coating |
| 24 | Second Surface Abrasive Coating |
| 26 | First Surface Abrasive Coating Inner Diameter |
| 28 | Second Surface Abrasive Coating Inner Diameter |
| 30 | First Surface Abrasive Coating Outer Diameter |
| 32 | Second Surface Abrasive Coating Outer Diameter |
| 34 | First Surface Non-abrasive Zone |
| 36 | Second Surface Non-abrasive Zone |
| 38 | First Surface Smooth Central Region |
| 40 | Second Surface Smooth Central Region |
| 44 | Non-abrasive Zone Radial Depth |
| 46 | Disk Base Thickness |
| 110 | Second Embodiment |
| 1 12 | Disk Perimeter Edge |
| 116 | First Aperture |
| 118 | Disk First Surface |
| 122 | Disk Abrasive Coating |
| 126 | Abrasive Interior Perimeter |
| 130 | Abrasive Outer Perimeter |
| 134 | Disk Non-abrasive Outer Zone |
| 210 | Third Embodiment |
| 212 | Disk Outer Edge/Perimeter |
| 218 | Disk First Surface |
| 226 | Abrasive Interior Perimeter |
| 230 | Abrasive Outer Perimeter |
| 234 | Disk Non-abrasive Region |
| 242 | Disk Surface Texture |
| 310 | Fourth Embodiment |
| 312 | Disk Perimeter Edge |
| 318 | Disk First Surface |
| 320 | Disk Second Surface |
| 322 | First Surface Abrasive Coating |
| 324 | Second Surface Abrasive Coating |
| 330 | First Surface Abrasive Coating Outer Diameter |
| 332 | Second Surface Abrasive Coating Outer Diameter |
| 334 | First Surface Non-abrasive Zone |
| 334a | First Surface Non-abrasive Zone Beveled Surface |
| | First Edge |
| 334b | First Surface Non-abrasive Zone Beveled Surface |
| | Second Edge |
| 336 | Second Surface Non-abrasive Zone Beveled Surface |
| | First Edge |
| 336a | Second Surface Non-abrasive Zone Beveled Surface |
| | Second Edge |
| 336b | Second Surface Non-abrasive Zone |
| 410 | Fifth Embodiment |
| 412 | Disk Perimeter Edge |
| 418 | Disk First Surface |
| 420 | Disk Second Surface |
| 422 | First Surface Abrasive Coating |
| 424 | Second Surface Abrasive Coating |
| 430 | First Surface Abrasive Coating Outer Diameter |
| 432 | Second Surface Abrasive Coating Outer Diameter |
| 434 | First Surface Non-abrasive Zone |
| 436 | Second Surface Non-abrasive Zone |
| 448 | First Surface Non-abrasive Zone Inner Zone |
| 448a | First Surface Non-abrasive Zone Inner Zone |
| | First Edge |
| 448b | First Surface Non-abrasive Zone Inner Zone |
| | Second Edge |
| 450 | Second Surface Non-abrasive Zone Inner Zone |
| 450a | First Surface Non-abrasive Zone Inner Zone |
| | First Edge |
| 450b | First Surface Non-abrasive Zone Inner Zone |
| | Second Edge |
| 452 | First Surface Non-abrasive Zone Edge Zone |
| 452a | First Surface Non-abrasive Zone Edge Zone |
| | First Edge |
| 452b | First Surface Non-abrasive Zone Edge Zone |
| | Second Edge |
| 454 | Second Surface Non-abrasive Zone Edge Zone |
| 454a | Second Surface Non-abrasive Zone Edge Zone |
| | First Edge |
| 454b | Second Surface Non-abrasive Zone Edge Zone |
| | Second Edge |
| 510 | Sixth Embodiment |
| 512 | Disk Perimeter Edge |
| 518 | Disk First Surface |
| 520 | Disk Second Surface |
| 522 | First Surface Abrasive Coating |
| 524 | Second Surface Abrasive Coating |
| 530 | First Surface Abrasive Coating Outer Diameter |
| 532 | Second Surface Abrasive Coating Outer Diameter |
| 534 | First Surface Non-abrasive Zone |
| 534a | First Surface Non-abrasive Zone First Edge |
| 534b | First Surface Non-abrasive Zone Second Edge |
| 536 | Second Surface Non-abrasive Zone |
| 536a | Second Surface Non-abrasive Zone First Edge |
| 536b | Second Surface Non-abrasive Zone Second Edge |
| 610 | Seventh Embodiment |
| 612 | Disk Perimeter Edge |
| 618 | Disk First Surface |
| 620 | Disk Second Surface |
| 622 | First Surface Abrasive Coating |
| 624 | Second Surface Abrasive Coating |
| 630 | First Surface Abrasive Coating Outer Diameter |
| 632 | Second Surface Abrasive Coating Outer Diameter |
| 634 | First Surface Non-abrasive Zone |
| 636 | Second Surface Non-abrasive Zone |
| 648 | First Surface Non-abrasive Zone Inner Zone |
| 648a | First Surface Non-abrasive Zone Inner Zone |
| | First Edge |
| 648b | First Surface Non-abrasive Zone Inner Zone |
| | Second Edge |
| 650 | Second Surface Non-abrasive Zone Inner Zone |
| 650a | First Surface Non-abrasive Zone Inner Zone |
| | First Edge |
| 650b | First Surface Non-abrasive Zone Inner Zone |
| | Second Edge |
| 652 | First Surface Non-abrasive Zone Edge Zone |
| 652a | First Surface Non-abrasive Zone Edge Zone |
| | First Edge |
| 652b | First Surface Non-abrasive Zone Edge Zone |
| | Second Edge |
| 654 | Second Surface Non-abrasive Zone Edge Zone |
| 654a | Second Surface Non-abrasive Zone Edge Zone |
| | First Edge |
| 654b | Second Surface Non-abrasive Zone Edge Zone |
| | Second Edge |

### DETAILED DESCRIPTION

Before beginning a detailed description of the subject invention, mention of the following is in order. When appropriate, like reference materials and characters are used to designate identical, corresponding, or similar components in differing figure drawings. The figure drawings associated with this disclosure typically are not drawn with dimensional accuracy to scale, i.e., such drawings have been drafted with a focus on clarity of viewing and understanding rather than dimensional accuracy.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

The terms abrasive and nonabrasive in this Specification are relative, as any surface in moving contact with a target surface will erode or abrade the target surface. In this context, “abrasive surface” means a surface to which an abrading substance (for example diamond grit of a selected nominal grit diameter to achieve a desired rate of removal from a target surface) has been adhered or which has been treated to create a surface roughness equivalent or corresponding to a nominal grit diameter surface application. In this context, “nonabrasive surface” means a surface to which no abrading substance or surface treatment has been applied, including polished surfaces as well as waffled or honeycombed surfaces which may create minor abrasion but primarily act to irrigate and/or lubricate the contact zone by creating a thin lubricating boundary layer, thereby reduce binding and frictional heating. Additionally, nonabrasive surface treatment such as waffling or dimpling may provide additional rigidity to a thin disk, allowing for reduced base thicknesses.

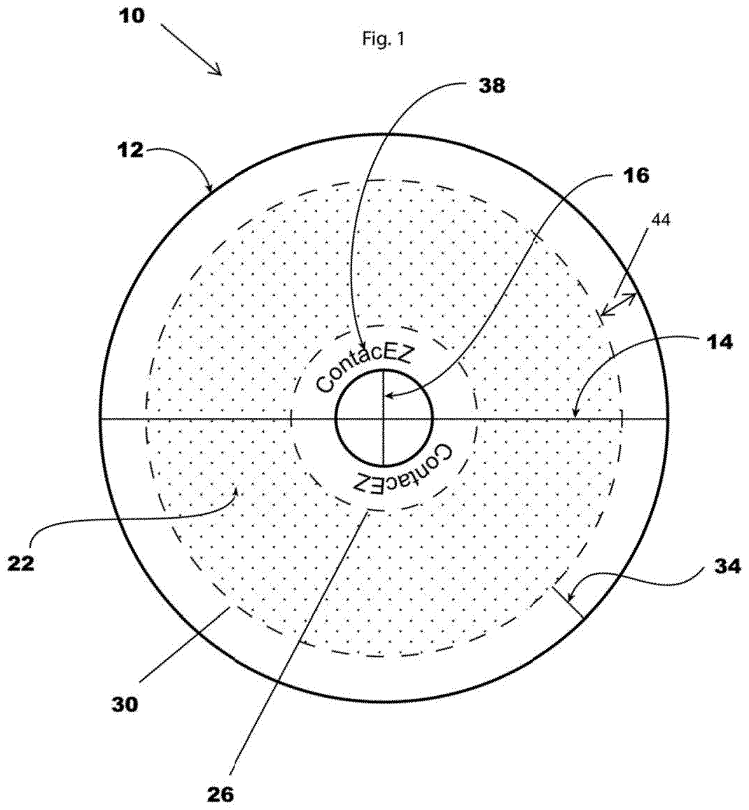

Referring to FIGS. 1 and 4-5, a first embodiment of a dental abrasive disk couplable to a dental driver is provided. In the embodiment, the disk 10 is defined by a perimeter edge 12 and diameter 14. First aperture 16 is provided for coupling to the shaft of a standard dental driver. Disk 10 includes a first surface 18 and opposite second surface 20, each having abrasive diamond coating 22, 24 respectively, disposed thereon, the abrasive coating 22, 24 extending from an abrasive interior perimeter 26, 28, respectively, to an abrasive outer perimeter 30, 32, respectively. Nonabrasive outer zone 34, 36, respectively extends from disk perimeter edge 12 to abrasive outer perimeter edges 30, 32. Abrasive interior perimeter 26, 28, defines a smooth central region 38, 40, respectively, surrounding first aperture 16, which does not interfere with coupling to a dental driver and which provides space for displaying branding and utilitarian information, such as disk specifications. Additionally, the disk could comprise a perforated disk, having a plurality of perforations distributed throughout the nonabrasive outer region. The perforations may also be distributed through the abrasive-coated inner region as well, although this may reduce the effectiveness of the abrasive coating.

The inner abrasive coating 22, 24 may be applied to either or both opposed disk surfaces 18, 20.

The base thickness 46 of the rotary disk may be selected for standard increments. The inventor has found that the most useful incremental thicknesses are 0.10 mm, 0.15 mm, 0.20 mm, 0.25 mm, 0.30 mm, 0.35 mm, 0.40 mm, 0.45 mm and 0.50 mm. The median size of abrasive particle coated on the disk may be varied to as well to obtain a combined base metal plus abrasive layer thickness of standard increments, including 0.10 mm, 0.15 mm, 0.20 mm, 0.25 mm, 0.30 mm, 0.35 mm, 0.40 mm, 0.45 mm, 0.50 mm and 0.60 mm.

A dental abrasive disk 10 may be directly couplable to the mandrel of a dental driver shaft, or can be made with an integral shaft, the shaft couplable to a dental driver tool.

Dental abrasive disks generally are provided in standardized diameters, such as 18 mm, 19 mm and 22 mm. In the described embodiment (not shown to scale in the drawings) the nonabrasive outer region extends approximately 36% of the disk diameter 14.

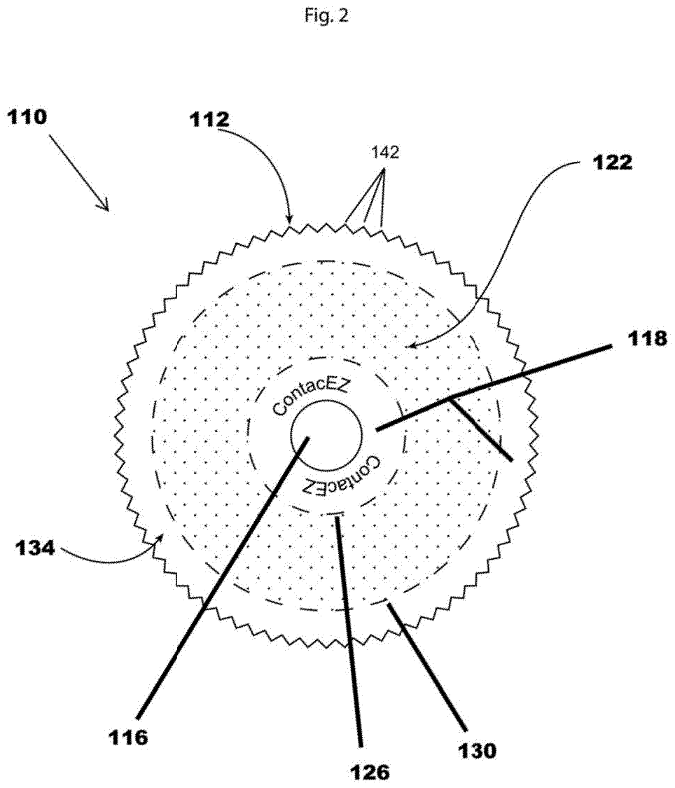

Referring to FIG. 2, a second embodiment 110 is shown. The dental abrasive disk includes first surface 118 and opposite second surface (not shown). First surface 118 includes abrasive diamond coating 122 extending from abrasive interior perimeter 126 to abrasive outer perimeter 130. In the embodiment, disk perimeter edge 112 provides a saw-tooth cutting edge. Nonabrasive outer zone 134 extends from perimeter edge 112 to abrasive outer perimeter 130. In the embodiment, the pointed extensions of the sawtooth cutting edge define the perimeter edge and diameter of the disk 110. The serrated saw teeth are the same thickness as the base disk thickness. In the embodiment, nonabrasive region 134 extends approximately 20% of the diameter of abrasive disk 110.

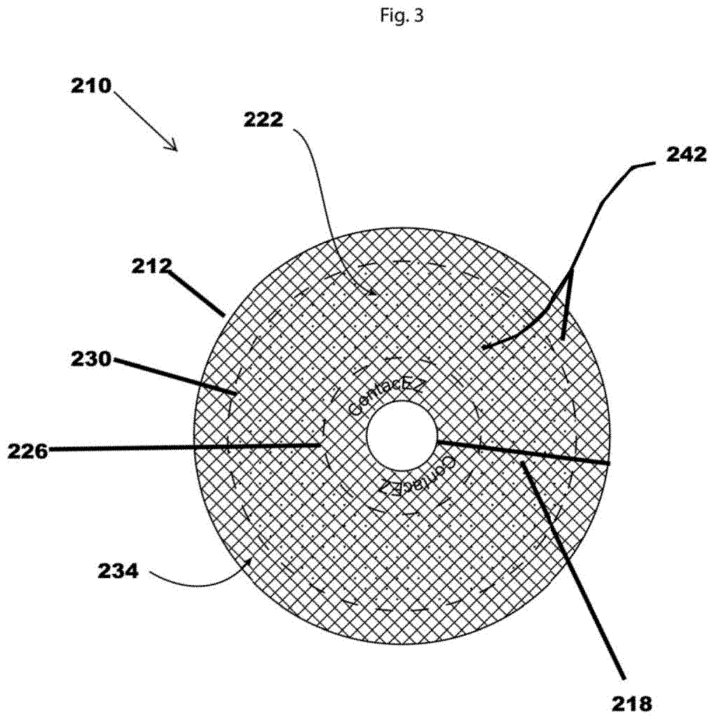

Referring to FIG. 3, a third embodiment 210 is shown. In the embodiment, disk first surface 218 and opposite second surface (not shown) provide a textured dimpled surface 242, in this case a waffle-texture. Diamond coated abrasive region 222 is provided which overlays the waffle-texture, extending from abrasive interior perimeter 226 to abrasive outer perimeter 230, with nonabrasive region 234 extending from abrasive outer perimeter 230 to outer edge 212. The texturing provides additional rigidity to the thin disk 210, and can reduce binding and frictional heating by creating a thin lubricating boundary layer. Dimpled surface texture 242 may lightly abrade a very thin layer of material during insertion, but also entrains water and/or saliva, creating a thin boundary later that reduces pulp-damaging frictional heating. Dimpled surface texture 242 may extend solely over the nonabrasive coated regions 234 (or, on first and second nonabrasive regions 34, 36 as shown in the first described embodiment), or may be applied to the entire first and second surfaces of the disc, with abrasive coating 222 applied over the dimpled surface texture 242.

The base thickness of the dimpled disk is defined by the ridges of the dimpling, not the indents or pits. The selected pattern may be imparted on the disk surface through stamp and die manufacturing methods which are known, or the dimpling may be formed into disk when the disk itself is formed. The described embodiments are formed from surgical-grade metals such as stainless steel and titanium because their toughness properties and manufacturing methods are well-known. However, it is contemplated that the disks could be formed using composites such as carbon fiber, or other materials which may be developed or commercialized in the future, if they can be meet the strength, safety and sterilization requirements of the dental surgery environment, and the invention is not limited to metal disks.

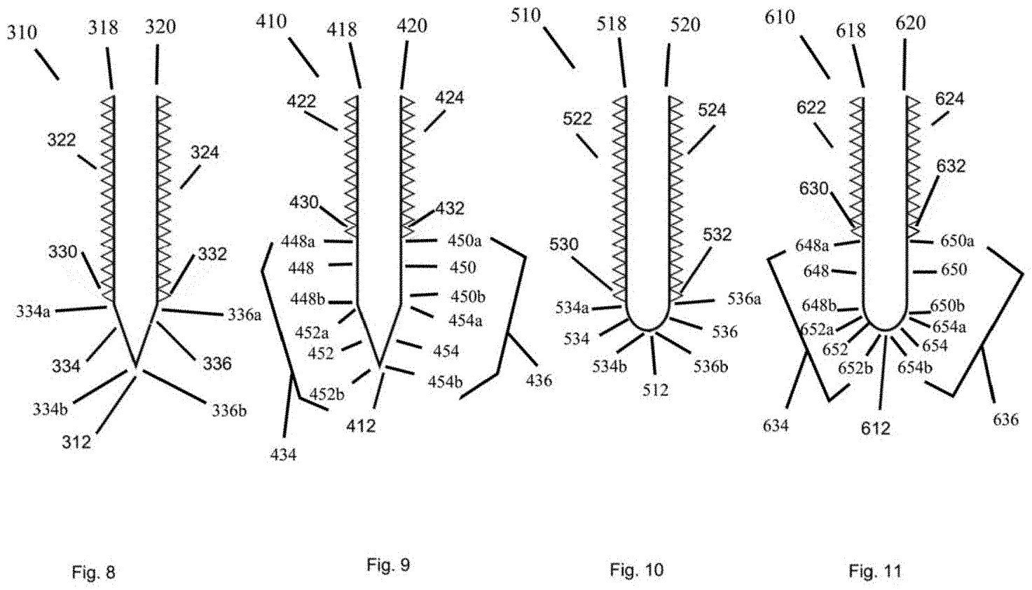

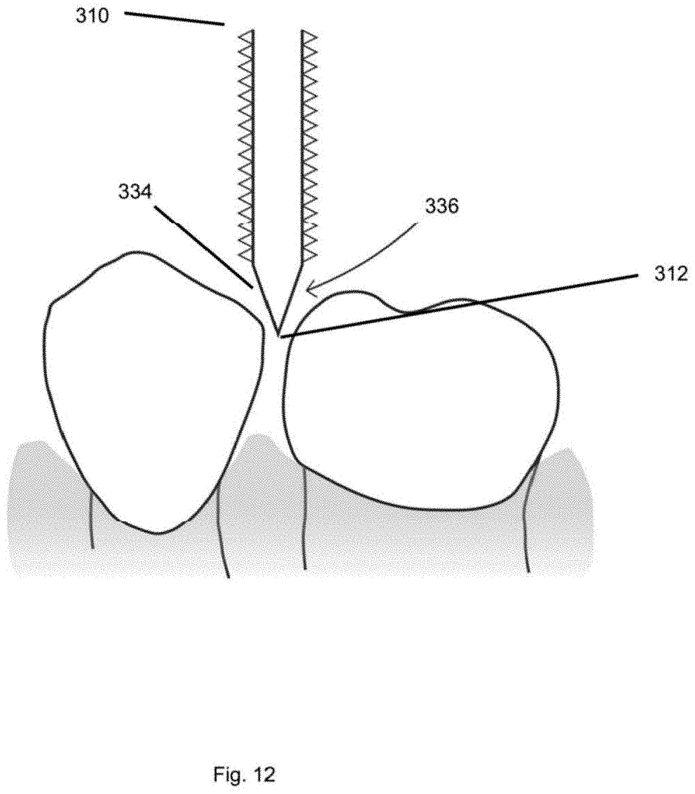

Referring to FIGS. 8 and 12, a fourth embodiment 310 is shown. In the embodiment, disk first surface 318 and opposite second surface 320 include respective first and second surface abrasive coatings 322, 324, extending to respective first and second surface abrasive coating outer diameters 330, 332. First and second surface nonabrasive zones 334, 336 form opposite converging beveled surfaces extending from first edges 334a, 336a proximate respective abrasive coating outer diameters 330, 332 to second edges 334b, 336b, respectively, which come together proximate disk perimeter edge 312 to form a narrowed edge. The nonabrasive double-beveled edge provides easier insertion and withdrawal between especially tight interproximal regions.

Referring to FIG. 9, a fifth embodiment 410 is shown. In the embodiment, disk first surface 418 and opposite second surface 420 include respective first and second surface abrasive coatings 422, 424, extending to respective first and second surface abrasive coating outer diameters 430, 432. Each of first and second surface nonabrasive zones 434, 436, include a first inner zone 448, 450 and a second edge zone 452, 454 extending from first inner zones 448, 450, respectively. First and second surface nonabrasive zone inner zones 448, 450, extend from first inner edges 448a, 450a to second outer edges 448b, 450b, respectively. First and second surface nonabrasive zone edge zones 452, 454 extend first inner edges 452a, 454a (coextensive with inner zone outer edges 448b, 450b) to second outer edges 452b, 454b, respectively, thereby defining an outer planar nonabrasive region extending inward from beveled edge zones 452, 454. First and second surface nonabrasive zone edge zones 452, 454 form opposite converging beveled surfaces coming together proximate disk perimeter edge 412 to form a narrowed edge. The nonabrasive double-beveled edge zones 452, 454 provide easier insertion and withdrawal between especially tight interproximal regions, and the extended planar inner nonabrasive zones 448, 450 provide assistance in aligning the disk 410 into the interproximal region before the abrasive portion contacts the tooth enamel.

Referring to FIG. 10, a sixth embodiment 510 is shown. In the embodiment, disk first surface 518 and opposite second surface 520 include respective first and second surface abrasive coatings 522, 524, extending to respective first and second surface abrasive coating outer diameters 530, 532. First and second surface nonabrasive zones 534, 536 form opposite converging radiused surfaces extending from first edges 534a, 536a proximate respective abrasive coating outer diameters 530, 532 to second edges 534b, 536b, respectively, which come together proximate disk perimeter edge 512 to form an ogival or continuous radiused edge. The nonabrasive double-radiused edge formed by 534, 536 and 512 provides effective insertion and withdrawal between especially tight interproximal regions, but minimizes potential tissue damage which might be caused by contact with a sharp perimeter edge. The nonabrasive double-radiused edge formed by 534, 536 and 512 defines an ogival shape or, as in the embodiment, a continuous radiused edge zone without discontinuities.

Referring to FIG. 11, a seventh embodiment 610 is shown. In the embodiment, disk first surface 618 and opposite second surface 620 include respective first and second surface abrasive coatings 622, 624, extending to respective first and second surface abrasive coating outer diameters 630, 632. Each of first and second surface nonabrasive zones 634, 636, include a first inner zone 648, 650 and a second radiused edge zone 652, 654 extending from first inner zones 648, 650, respectively. First and second surface nonabrasive zone inner zones 648, 650, extend from first inner edges 648s, 650a to second outer edges 648b, 650b, respectively. First and second surface nonabrasive zone edge zones 652, 654 extend first inner edges 652a, 654a (coextensive with inner zone outer edges 648b, 650b) to second outer edges 652b, 654b, respectively, thereby defining an outer planar nonabrasive region extending inward from radiused edge zones 652, 654. First and second surface nonabrasive zone edge zones 652, 654 form opposite converging radiused surfaces coming together proximate disk perimeter edge 612 to form an ogival or continuously radiused edge. The nonabrasive double-radiused edge zones 652, 654 provide easier insertion and withdrawal between especially tight interproximal regions with reduced risk of tissue damage caused by contact with sharp edge surfaces, and the extended planar inner nonabrasive zones 648, 650 provide assistance in aligning the disk 610 into the interproximal region before the abrasive portion contacts the tooth enamel.

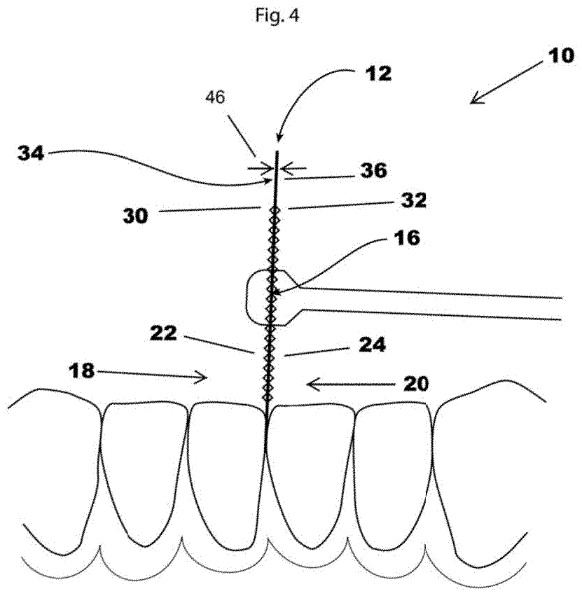

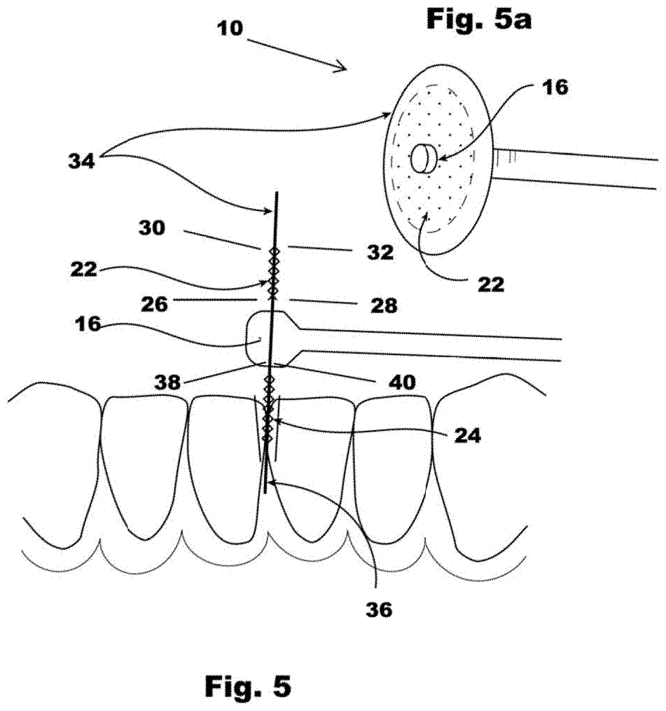

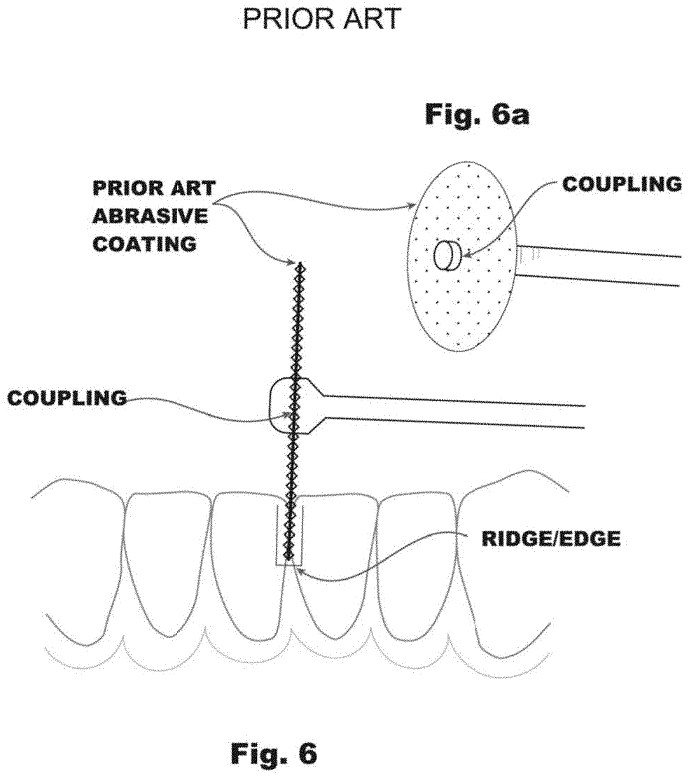

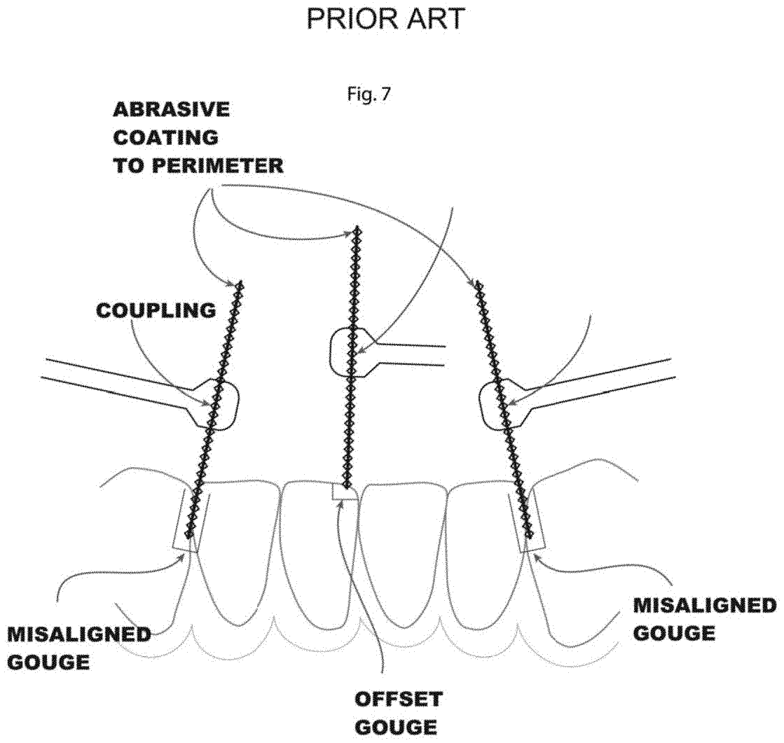

Referring to FIGS. 4, 5 and 5a (and FIG. 12, which is similar in operation though differing somewhat in structure), the operation of a first embodiment 10 is shown. The dental disk 10 has plain outer edge 12 and outer region 34, 36 which have no diamond particle or other abrasive coating. The nonabrasive outer region 12, 34, 36 of the disk 10 guides the disk 10 to stay in middle of interproximal space, and prevent unintentional cutting in to enamel or gingival tissue. The nonabrasive perimeter edge 12 of the disk 10 prevents the rotary disk 10 to proceed in the wrong direction, which can create gouges and ledges which may irreversibly damage the tooth structure.

In use, a nonabrasive region having a radial depth 44 between approximately 20% to approximately 40% of the disk radius (½ of disk diameter 14) has been found to present an effective range to provide a nonabrasive guide/engagement depth and sufficient abrasive surface. The specific ration may be selected by a qualified dental practitioner based upon the specific patient characteristics, such as the size of the patient's mouth (which defines the maneuvering space), the tooth crown height/embrasure depth, the depth of the region to be abraded or shaped, and the spacing or degree of contact between adjacent teeth. In preferred practice, the improved dental abrasive disks 10, 110, 210 would be provided as a system, with a range of base thickness and abrasive thicknesses, and a range of disk diameters with varied ratios of nonabrasive regions within the range 20% to 40% in order to adapt to specific patient parameters. Some procedures might be performed in stages, with a disk of different dimensions/ratios being used for each stage.

In application, a dental abrasive disk (10, 110, 210, 310, 410, 510, 610 & etc.) as described and claimed herein may include combinations of the elements of the described embodiments. For example, a dental abrasive disk may include a first or second disk surface having abrasive and nonabrasive zones and perimeter edges, and including nonabrasive outer zones surfaces or waffled/honeycombed outer zone surfaces in any combination of the described embodiment elements, and may include one disk surface having no abrasive portion at all with the opposite surface having a combined abrasive/nonabrasive surface combination as explained in the described embodiments. The inventive apparatus is therefore not limited to the described embodiments, but includes different combinations of the elements of the described embodiments, providing great flexibility in providing effective apparatus specially configured for various conditions.

Those skilled in the art will recognize that numerous modifications and changes may be made to the preferred embodiment without departing from the scope of the claimed invention. It will, of course, be understood that modifications of the invention, in its various aspects, will be apparent to those skilled in the art, some being apparent only after study, others being matters of routine mechanical, chemical and electronic design. No single feature, function or property of the preferred embodiment is essential. Other embodiments are possible, their specific designs depending upon the particular application.

I claim:

1. A dental abrasive disk defined by a disk radius, an outer perimeter edge, opposite disk first and second surfaces and a base thickness, the disk further comprising:
a center coupling, the coupling adapted to couple to a dental driver or mandrel improved dental abrasive disk;
one of the first and second disk surfaces defining a first partially abrasive disk surface and the opposite disk surface defining a continuous nonabrasive disk surface;
the partially abrasive disk surface including an abrasive inner abrasive zone and an outer nonabrasive zone, the outer nonabrasive zone extending radially from the disk perimeter edge inwardly to an abrasive zone perimeter and the inner abrasive zone extending radially from the abrasive zone perimeter to an abrasive zone inner edge proximate the center coupling, the radial distance from the abrasive zone perimeter to the abrasive zone inner edge defining an abrasive zone radial depth and the radial distance from the disk perimeter edge to the abrasive zone perimeter defining a nonabrasive zone radial depth;
wherein the ratio of the nonabrasive zone radial depth to the disk radius of the partially abrasive surface is in the range 20% to 40%.

2. The apparatus of claim 1, further comprising:
each of the first and second disk surfaces defining respective identical first and second partially abrasive disk surfaces.

3. The apparatus of claim 1, further comprising:
the partially abrasive disk surface nonabrasive zone and the nonabrasive disk surface including a dimpled surface texture.

4. The apparatus of claim 2, further comprising:
each of the first and second partially abrasive disk surface outer nonabrasive zones including a dimpled surface texture.

5. The apparatus of claim 1, further comprising:
wherein at least the outer nonabrasive zone includes a plurality of perforations distributed throughout the nonabrasive zone.

6. The apparatus of claim 6, further comprising:
wherein the entire disk includes a plurality of perforations distributed throughout the disk area.

7. The apparatus of claim 2, further comprising:
wherein at least the outer nonabrasive zones include a plurality of perforations distributed throughout the nonabrasive zone.

8. The apparatus of claim 2, further comprising:
wherein the entire disk includes a plurality of perforations distributed throughout the disk area.

9. The apparatus of claim 1, further comprising:
each of the first partially abrasive disk surface outer nonabrasive zone and opposite continuous nonabrasive disk surface including convergent first and second beveled surfaces proximate the disk perimeter edge.

10. The apparatus of claim 2, further comprising:
each of the first and second partially abrasive disk surface outer nonabrasive zones including convergent first and second beveled surfaces proximate the disk perimeter edge.

11. The apparatus of claim 1, further comprising:
each of the first partially abrasive disk surface outer nonabrasive zone and opposite continuous nonabrasive disk surface including convergent first and second radiused surfaces proximate the disk perimeter edge.

12. The apparatus of claim 2, further comprising:
each of the first and second partially abrasive disk surface outer nonabrasive zones including convergent first and second radiused surfaces proximate the disk perimeter edge.

13. The apparatus of claim 1, further comprising:
the disk perimeter edge further including a serrated profile.

14. The apparatus of claim 2, further comprising:
the disk perimeter edge further including a serrated profile.
